(19) United States
(12) Patent Application Publication
(10) Pub. No.: US 2026/0181366 A1
(43) Pub. Date: Jun. 25, 2026

(54) SYSTEMS AND METHODS FOR MANAGING COMMUNICATIONS DURING WATER EXPOSURE CONDITIONS

(71) Applicant: MOTOROLA SOLUTIONS, INC., Chicago, IL (US)

(72) Inventors: Chun Wen OOI, Georgetown (ML); Pedram DJAVADKHANI, Georgetown (MY)

(21) Appl. No.: 18/987,454

(22) Filed: Dec. 19, 2024

(51) Int. Cl. H04W 4/90; H04B 17/318; H04W 4/12

(52) U.S. Cl. CPC H04W 4/90; H04B 17/328; H04W 4/12

(57) ABSTRACT

An example method for managing communications during a water exposure condition includes: detecting, at a water sensor of a recipient device, a water exposure condition of the recipient device; in response to detecting the water exposure condition, selecting a storage device for storing an incoming audio message from a source device to the recipient device based on the water exposure condition; storing the incoming audio message at the storage device; detecting alleviation of the water exposure condition at the recipient device; and in response to detecting the alleviation of the water exposure condition, releasing the stored incoming audio message for output at the recipient device.

### BACKGROUND

Radio frequency communications are used for wireless communications between remote devices. Communications protocols to support transmission and reception of the messages to reduce communication breakdowns in real-time communication situations, such as in emergency response situations.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a schematic diagram of an example system for managing communications during water exposure conditions.

FIG. 2 is a block diagram of certain internal components of the communications device of FIG. 1.

FIG. 3 is a flowchart of an example method for managing communications during water exposure conditions.

FIG. 4 is a schematic diagram of a first example performance of a portion of the method for managing communications during water exposure conditions.

FIG. 5 is a schematic diagram of a second example performance of a portion of the method for managing communications during water exposure conditions.

FIG. 6 is a schematic diagram of an example performance of another portion of the method for managing communications during water exposure conditions.

FIG. 7 is a flowchart of an example method for supporting communications during water exposure conditions.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In real-time communication use scenarios, such as emergency response situations, remote maintenance work, and the like, important and time-sensitive information may be transmitted via radio frequency communication. Radio frequency (RF) communications are generally robust, however may be affected by water, which may act as a barrier for audio waves or for RF waves. Thus, when a recipient device is exposed to water, for example by being submerged in water, or in the presence of loud, running water, the recipient device may still receive audio messages robustly via RF communications, however audio playback of such messages in the presence of the water may render the audio messages substantially inaudible to users of the recipient device. In examples where the RF communications of a recipient device are affected by water, the audio message may be broken and unintelligible, in addition to the risk of being substantially inaudible to users. Accordingly, communications, particularly audio communications, need to be technically managed when the recipient device is experiencing a water exposure condition.

In accordance with one example embodiments, a method for managing communications during water exposure conditions includes: detecting, at a water sensor of a recipient device, a water exposure condition of the recipient device; in response to detecting the water exposure condition, selecting a storage device for storing an incoming audio message from a source device to the recipient device based on the water exposure condition; storing the incoming audio message at the storage device; detecting alleviation of the water exposure condition at the recipient device; and in response to detecting the alleviation of the water exposure condition, releasing the stored incoming audio message for output at the recipient device.

In accordance with another example embodiment, a communications device includes: a water sensor configured to detect a water exposure condition of the communications device; a communications interface configured to communicate with a source device; and a controller interconnected with the water sensor and the communications interface, the controller configured to: in response to detection of the water exposure condition by the water sensor, select a storage device for storing an incoming audio message from a source device to the communications device based on the water exposure condition; cause the incoming audio message to be stored at the storage device; in response to detection of alleviation of the water exposure condition by the water sensor, cause the stored incoming audio message to be released for output at the communications device.

In accordance with another example embodiment, another communications device includes: a communications interface configured to communicate with a recipient device; and a controller interconnected with the communications interface, the controller configured to: receive an alert from the recipient device, the alert indicating a water exposure condition of the recipient device; present a notification that outgoing audio messages to the recipient device are stored at a storage device; receive a subsequent alert from the recipient device, the subsequent alert indicating alleviation of the water exposure condition; and present a notification that the outgoing audio messages are released from the storage device.

Each of the above-mentioned embodiments will be discussed in more detail below, starting with example system and device architectures of the system in which the embodiments may be practiced, followed by an illustration of processing blocks for achieving an improved technical method, device, and system for managing communications during water exposure conditions.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

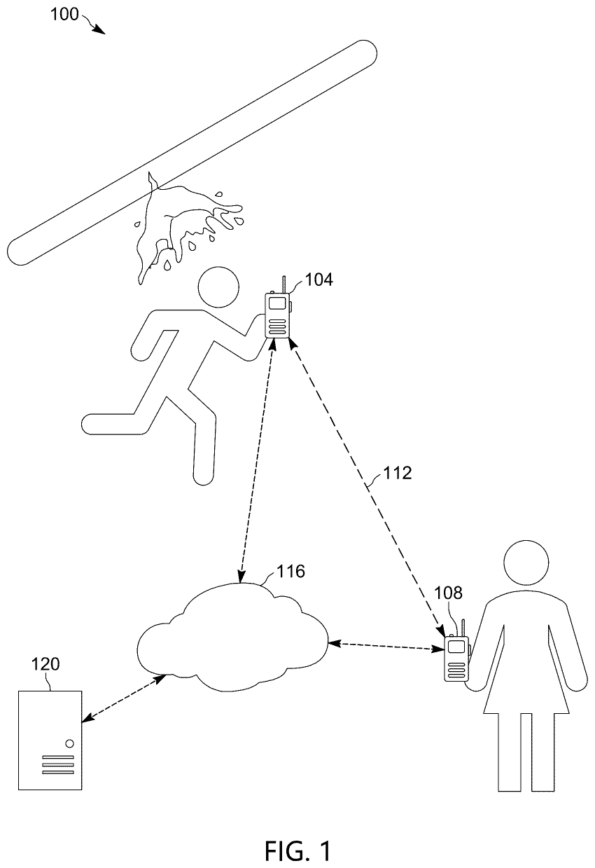

Referring now to the drawings, and in particular FIG. 1, an example system 100 for managing communications during a water exposure condition is depicted. The system 100 includes a wireless communications device 104 configured for wireless communications with another wireless communications device 108. For example, each of the devices 104 and 108 may be endpoint devices, such as handheld transceivers (e.g., walkie-talkies), two-way radios, short-range radio transceivers, or other suitable devices configured to communicate via radio frequency (RF) communications, and hence may also be referred to herein as RF devices 104 and 108. The devices 104 and 108 may be in communication with one another via a direct peer-to-peer link 112, as illustrated in the present example, or may each be connected to a network 116, which may include other devices such as a network server 120, other endpoint devices, other intermediary devices, such as a dedicated message repository or similar, and the like.

In particular, the devices 104 and 108 are configured for bi-directional RF communications, such that RF signals are capable of being sent from the device 104 to the device 108 and from the device 108 to the device 104. That is, either of the devices 104 and 108 is capable of acting as both a source device and a recipient device for the RF communications. In the present disclosure, the RF device 104 is referred to as the recipient device 104, and the RF device 108 is referred to as the source device 108, such that RF communications are sent from the source device 108 to the recipient device 104. It will be appreciated that this nomenclature is not limiting, and that in other examples, the RF device 108 may be the recipient device and the RF device 104 may be the source device.

Radio frequency communications may be useful for communications in industrial settings for communications between users remote from one another, for example, of a large facility or warehouse, between a centralized or supervisory hub (e.g., a command center) and on-site operators or crew members, or the like. For example, the RF devices 104 and 108 may be deployed by emergency services, maintenance crews, construction services, or the like and generally provide dependable and robust communications capabilities in a variety of environments. However, in some particular conditions, such as exposure to water, the water may obstruct audio signals transmitted between the RF devices 104 and 108. In particular, water may absorb and/or distort sound waves. For example, if a pipe bursts at the location of the recipient device 104, the user of the recipient device 104 may be unable to hear audio messages transmitted from the source device 108 to the recipient device 104 over the sound of the water. In some water exposure conditions, the water may further obstruct the RF capabilities of the recipient device 104. In either case, water exposure conditions may render audio messages streamed from the source device 108 to the recipient device 104 ineffectual, leading to a breakdown in communication. This may have a particularly negative effect in emergency situations in which an urgent, important and/or time-sensitive audio message is being transmitted.

Thus, in accordance with the present disclosure, the recipient device 104 is equipped with a water sensor (as will be shown and described below) configured to detect a water exposure condition of the recipient device 104. In particular, the water sensor is sensitive to the presence of water to detect the water exposure condition. In response to detecting the water exposure condition, the recipient device 104 may select a storage device to store incoming audio messages from the source device 108. Specifically, the selection of the storage device may be based on parameters of the water exposure condition, such as the quality of RF capabilities, and may be one of the: the recipient device 104, the source device 108, or a network device such as the network server 120. Incoming audio messages may be stored at the selected storage device until the water exposure condition is alleviated (e.g., as detected by the water sensor), after which the recipient device 104 may cause the stored incoming audio message to be released for output at the recipient device 104.

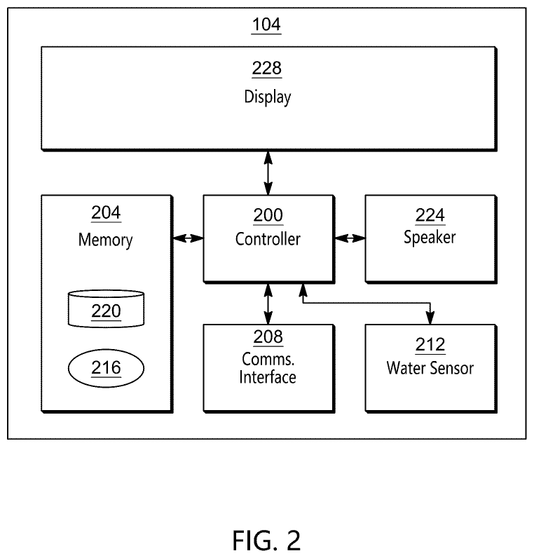

Referring to FIG. 2, certain internal components of a communications device, such as the recipient device 104, are illustrated. The recipient device 104 includes a controller 200, interconnected with a non-transitory computer-readable storage medium, such as a memory 204, a communications interface 208, and a water sensor 212. The source device 108 may include similar internal components.

The controller 200 may include any suitable processor, including one or more logic circuits, processing units, microprocessors, GPUs (Graphics Processing Units), ASICs (application-specific integrated circuits), FPGAs (field-programmable gate arrays) and/or other suitable units capable of executing instructions to carry out the functionality described herein. The memory 204 includes a combination of volatile memory (e.g., Random Access Memory or RAM) and non-volatile memory (e.g., read only memory or ROM, Electrically Erasable Programmable Read Only Memory or EEPROM, flash memory, etc.). The controller 200 and the memory 204 may each comprise one or more integrated circuits.

The memory 204 stores computer-readable instructions for execution by the controller 200. In particular, the memory 204 stores an application 216 which, when executed by the controller 200, configures the controller 200 to perform various functions discussed below in greater detail and related to the water exposure condition operation of the device 104. In particular, the application 216 may include code operable to manage storage of incoming audio messages during a water exposure condition. Some or all of the application 216 may also be implemented as a suite of distinct applications. Those skilled in the art will appreciate that the functionality implemented by the controller 200 via execution of the application 216 and the code contained therein may also be implemented by one or more specially designed hardware and firmware components. The memory 204 may also store a repository 220 storing rules and data for the water exposure condition operation. For example, the repository 220 may be configured to store incoming audio messages, speech-to-text conversions of audio messages, or the like.

The communications interface 208 enables the recipient device 104 to exchange data with other computing devices, such as the source device 108 and the network server 120. In particular, the communications interface 208 is configured for RF communications and hence may include suitable hardware, including a radio transmitter, receiver (or transceiver), antennae and the like allowing the device 104 to communicate, for example via the link 112 to the device 108.

The communications interface 208 may further include additional suitable hardware (e.g., network interface controllers or the like) allowing the device 104 to communicate with other devices over other types of communications protocols. The specific components of the communications interface 208 may be selected based on the other types of networks or other links that the device 104 is to communicate over. For example, the communications interface 208 may be configured for wired communications, including Ethernet, USB (Universal Serial Bus), twisted pair, coaxial, fiber-optic or similar physical connections, or wireless communications, including one or more of the Internet, a digital mobile radio (DMR) network, a Project 25(P25 ) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series standard), a Worldwide Interoperability for Microwave Access (WiMAX) network, for example operating in accordance with an IEEE 802.16 standard, and/or another similar type of wireless network, combinations of the above, and the like.

The water sensor 212 is a sensor which is sensitive to the presence of water. For example, the water sensor 212 may include an electrical circuit which is completed when water is present, for example in the form of a printed sensor having traces printed thereon, a conductive rope or cable sensor, or the like. The water sensor 212 is interconnected to the controller 200, for example to allow the controller 200 to monitor the resistance through the electrical circuit of the water sensor 212 and identify changes in resistance as completion of the electrical circuit, or other suitable methodologies. In other examples, the water sensor 212 may operate under other principles, such as effecting a reversible chemical reaction or other suitable principle operable based on the presence of water.

The recipient device 104 further includes one or more input and/or output devices, including a speaker 224 configured to output audio data, and, in the present example, a display 228 configured to display visual data. In other examples, the recipient device 104 may include only the speaker 224 and not the display 228. Further, the recipient device 104 may include input devices such as one or more buttons (e.g., allowing push-to-talk functionality), keypads, touch-sensitive display screens or the like for receiving input.

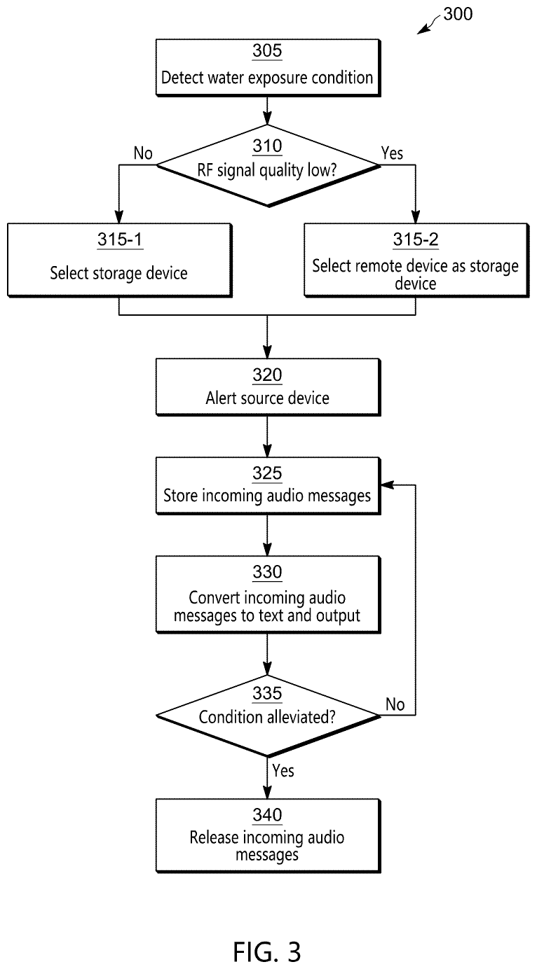

Turning now to FIG. 3, the functionality implemented by the recipient device 104 will be discussed in greater detail. FIG. 3 illustrates a flowchart of an example method 300 of managing the storage of incoming audio messages during a water exposure condition. The method 300 will be discussed in conjunction with its performance in the system 100, and particularly by the recipient device 104, via execution of the application 216. In other examples, some or all of the method 300 may be performed by other suitable devices or systems, such as the device 108.

The method 300 is initiated at block 305, where the recipient device 104 detects a water exposure condition of the recipient device 104. In particular, the water sensor 212 may detect the presence of water, which may result in the assessment of the water exposure condition. In some examples, the controller 200 may assess that a water exposure condition exists when a threshold amount of water is detected by the water sensor 212, for example, based on detection of the water being consistent over a predefined time period or the like, to differentiate from minor incidental water exposure.

In some examples, the water exposure condition may be verified or validated by a secondary analysis of the environment of the recipient device 104 in which the water exposure condition is detected. For example, the secondary analysis may include video analysis from a video camera, such as a security or surveillance camera, a body-worn camera of an operator of the device 104, or the like, audio analysis of audio data captured by the device 104, from another microphone source, such as a microphone integrated with a security or surveillance camera or body-worn camera, or the like. In other examples, the secondary analysis may include an assigned task analysis to predict a location of the operator of the device 104 and a likelihood of the water exposure condition. In still further examples, the secondary analysis may include an analysis of the antenna received signal strength indicator (RSSI) to determine if the signal strength has been affected. In some examples, the RSSI analysis may include an analysis of both RF signal quality and/or other wireless communication signal quality. In still further examples, other types of secondary analysis to validate the water exposure condition are also contemplated.

At block 310, the device 104 determines whether a radio frequency signal quality is below a threshold quality level. In particular, the recipient device 104 may additional identify a nature of the water exposure condition with respect to RF communication capabilities of the device 104. That is, the device 104 may assess whether or not the RF communications are affected by the water exposure condition. For example, the recipient device 104 may assess the RSSI of incoming RF signals, or other signal quality indicators and determine whether the RSSI or other indicator is above the predefined threshold quality level, indicating that the water exposure condition allows the RF communications to still operate substantially normally, and make a negative determination at block 310. If the water exposure condition has resulted in a sufficient reduction in RF signal quality so as to substantially affect RF communication capabilities of the device 104, the device 104 may make an affirmative determination at block 310 that the RF signal quality is below the threshold quality level.

If the determination at block 310 is negative, that is, the RF signal quality is above the threshold quality level, then the device 104 proceeds to block 315-1. At block 315-1, the device 104 is configured to select a storage device for storing incoming audio messages, which may be the recipient device 104 itself. In particular, since the RF signal quality is at or above the threshold quality level, the device 104 is technically capable of receiving the incoming audio messages from the source device 108. However, the water exposure condition may render the audio output of the incoming audio message impractical. Accordingly, the recipient device 104 may be capable of acting as the storage device, and hence may be selected as the storage device, such that the device 104 may change its processing behavior for incoming audio messages to store the incoming audio messages for later playback.

In other examples, the recipient device 104 may select another device, such as the source device 108, the network server 120, or another suitable network device remote from the recipient device 104 as the storage device. In some examples, the selected storage device may be a device through which the RF communications between the recipient device 104 and the source device 108 are routed. Thus, if the devices 104 and 108 are configured for peer-to-peer communications via the link, then the source device 108 may be selected as the storage device. If the RF communications are routed through additional devices on the network 116, then one or more of the devices, such as the network server 120, through which the RF communications are routed may be selected as the storage device. In examples where the selected storage device is remote from the device 104, the device 104 may additionally send a storage request message to the selected storage device to cause the selected storage device to store the incoming audio messages as part of the selection operation at block 315-1.

If the determination at block 310 is affirmative, that is, the RF signal quality is below the threshold quality level, then the device 104 proceeds to block 315-2. At block 315-2, the device 104 is configured to select a storage device for storing incoming audio messages which is remote from the device 104. For example, the device 104 may select the source device 108, the network server 120, or another network device as the storage device. In particular, since the RF signal quality is below the threshold quality level, the device 104 may not receive some or all of the incoming audio messages and/or the quality of the received incoming audio messages may be degraded due to the water exposure condition. Accordingly, to preserve the integrity of the incoming audio messages, the device 104 may select a device remote from the device 104 to store incoming audio messages destined until the water exposure condition is alleviated.

In such examples, the device 104 may additionally send a storage request message to the selected storage device to cause the storage device to store the incoming audio messages as part of the selection operation at block 315-2. Since the RF capabilities of the device 104 may be degraded, the storage request message may be a simple, repetitive signal such as a single repeating pulse of a predefined length.

After selection of a suitable storage device at block 315-1 or 315-2, the device 104 is configured to proceed to block 320. At block 320, the device 104 may alert the source device 108 that the recipient device 104 is experiencing the water exposure condition and that, as a result of the water exposure conditions, audio messages from the source device 108 to the recipient device 104 are being stored and are not being output at the recipient device. In some examples, the storage request message may be integrated with the alert, or may function as the alert to the source device 108. In other examples, the recipient device 104 may transmit a separate alert to the source device 108.

At block 325, incoming audio messages from the source device 108 to the recipient device 104 are stored at the selected storage device. In particular, if the selected storage device is the recipient device 104, then the recipient device 104 may modify the processing of incoming audio messages to store them, for example in the repository 220, rather than outputting the audio data at the speaker 224. Similarly, in response to the storage request message, the selected remote storage device, such as the source device 108 or the network server 120, is caused to modify processing of audio messages, for example, to both transmit the audio message to other devices in a talk group or the like, as well as to store a copy of the audio message for subsequent transmission to the recipient device 104.

In addition to the audio data representing the audio message, the storage device may additionally store metadata, such as the date and time that the message was stored, or the like.

In particular, at block 330, in addition to storing the incoming audio message, the storage device may additionally convert the incoming audio message to a text message (e.g., via a speech-to-text functionality and/or suitable audio analysis), and the storage device may additionally store the text data representing the text message. In some examples, such as if the recipient device 104 is the storage device, the converted text message may be displayed at the display 228 of the recipient device 104 in real-time instead of outputting the audio message at the speaker 224. In other examples, if the RF signal quality is sufficient, the remote storage device may send the text data to the recipient device 104 to display the text message at the display 228 instead of the audio message. That is, the device 104 may obtain the text message representing the incoming audio message from the remote storage device (e.g., from the device 108 or the server 120) and display the text message. If the RF signal quality is insufficient, then the remote storage device may store the text data with the audio message.

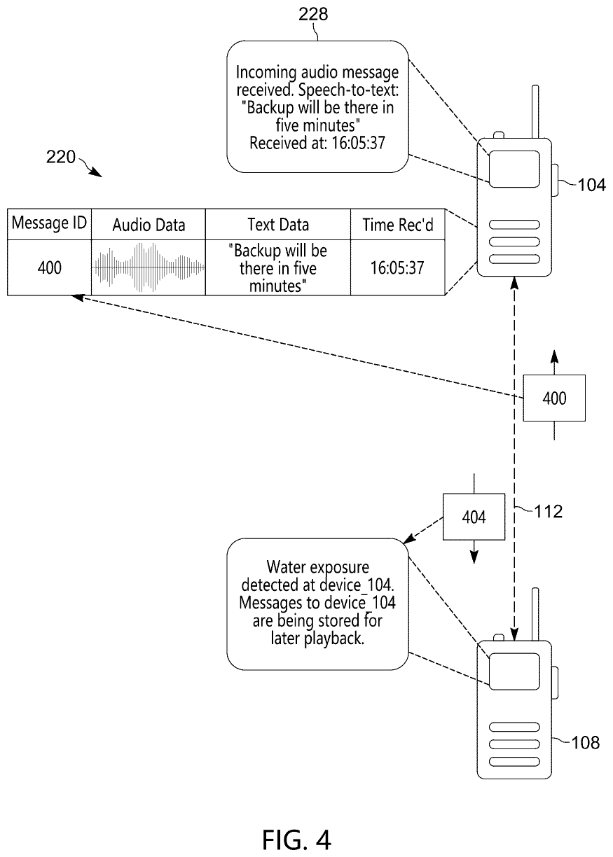

For example, referring to FIG. 4, a schematic diagram of the system 100 during a water exposure condition of the device 104 is depicted. In particular, in the example of FIG. 4, the device 104 may determine that the RF signal supported by the link 112 is at or above the threshold quality level, and hence may select the recipient device 104 itself as the storage device. Accordingly, when an incoming audio message 400 is sent from the source device 108 to the recipient device 104, the recipient device 104 may store the incoming audio message 400, including audio data defining the incoming audio message, for example in the repository 220. The recipient device 104 may additionally store metadata, such as the time received, and may further apply a speech-to-text conversion or audio analysis on the audio data and store the resulting text data in the repository 220. The speech-to-text text data and/or any additional metadata may additionally be displayed in real-time at the display 228 to allow the operator of the device 104 to receive and act on the information in the audio message as appropriate.

Further, in response to detection of the water exposure condition and/or in response to the receipt and storage of the message 400, the recipient device 104 may send an alert 404 to the source device 108 to alert the source device 108 of the water exposure condition of the recipient device 104 and that audio messages to the recipient device 104 are being stored for later playback. For example, in response to the alert 404, the source device 108 may display a notification for the operator of the source device 108. In other examples, an audio alert, another type of alert, or combinations of notifications are also contemplated.

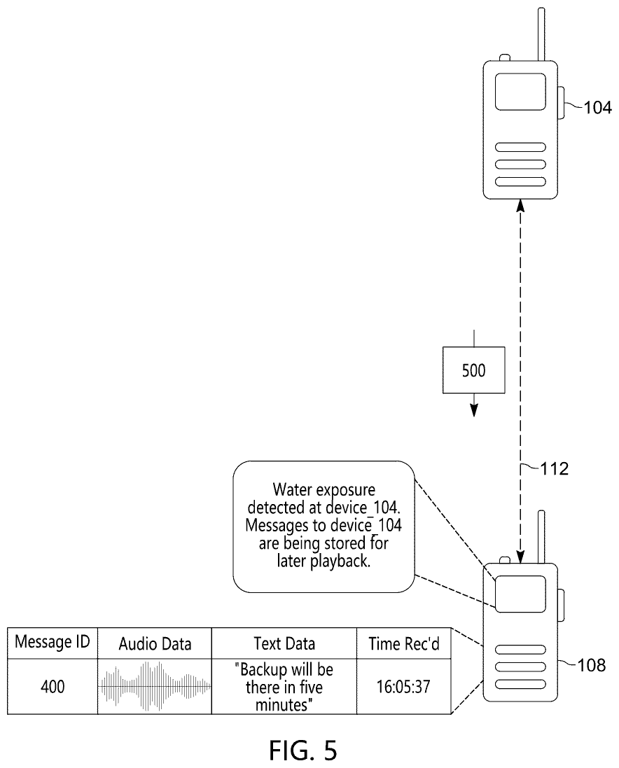

According to another example depicted in FIG. 5, another schematic diagram of the system 100 during a water exposure condition of the device 104 is depicted. In particular, in the example of FIG. 5, the device 104 may determine that the RF signal supported by the link 112 is below the threshold quality level, and hence may select the source device 108 as the storage device. Accordingly, the device 104 may send a storage request message 500 to the source device 108. The storage request message 500 may be a simple series of pulses of a predefined length to reduce the complexity and therefore to increase the likelihood that the message 500 will be received and interpretable by the source device 108 with the degraded RF signal quality of the link 112.

Thus, when the source device 108 identifies an outbound audio message 400, the source device 108 may store the message 400. The source device 108 may similarly apply a speech-to text conversion or audio analysis on the audio data and store the resulting text data in association with the message 400, together with any additional metadata. Further, the storage request message 500 may act as an alert for the source device 108 that the recipient device 104 is experiencing the water exposure condition and that audio messages, such as the message 400, are being stored for later playback. The source device 108 may display a notification for the operator of the source device 108.

Returning to FIG. 3, at block 335, the device 104 determines whether the water exposure condition is alleviated, for example based on the signals detected by the water sensor 212. An alleviation condition may similarly include detecting a lack of water by the water sensor 212 continuously for at least a threshold period of time. The alleviation of the water exposure condition may additionally be verified or validated by a secondary source, such as video analysis, audio analysis, RSSI analysis, or the like. In some examples, the alleviation of the water exposure condition may be affirmed via an input from the operator of the recipient device 104, for example by pressing a button, a predefined sequence of inputs, or the like.

If the determination at block 335 is negative, that is, the water exposure condition is still present, then the device 104 returns to block 325 to store the incoming audio messages (e.g., at the recipient device 104 itself) or to cause a remote storage device to store the incoming audio messages.

If the determination at block 335 is affirmative, that is, the water exposure condition is alleviated, then the device 104 proceeds to block 340. At block 340, the device 104 releases or causes the incoming audio messages to be released. In particular, if the device 104 is the selected storage device, then at block 340, the device 104 may retrieve the stored incoming audio messages, for example from the repository 220, and output the audio messages at the speaker 224. In some examples, in addition to outputting the audio messages, the device 104 may additionally obtain the metadata associated with the audio message and present the metadata, for example on the display 228 to provide the user with the context in which the message was stored. Thus, for example, if the audio message included time-sensitive information, the user may compare the received time of the metadata with the current time to evaluate the relevance of the time-sensitive information.

If the selected storage device is remote from the device 104, then at block 340, the device 104 may cause the incoming audio messages to be released from the remote device, for example by sending a release request message to the remote device. The remote storage device may then release the incoming audio messages to the recipient device 104 with the stored metadata. Upon receipt of the incoming audio messages, the recipient device 104 may output the audio messages at the speaker 224 and present the metadata on the display 228.

In some examples, additionally at block 340, in response to outputting the incoming audio messages, the recipient device 104 is configured to alert the source device 108 that the audio messages are released with a subsequent alert. In examples where the source device 108 is the storage device, the release request message may be integrated with or function as the alert that the audio messages are released. In other examples, the recipient device 104 may send an independent alert to the source device 108.

In some examples, some of the blocks of the method 300 may be performed in an order other than that depicted, and/or substantially simultaneously.

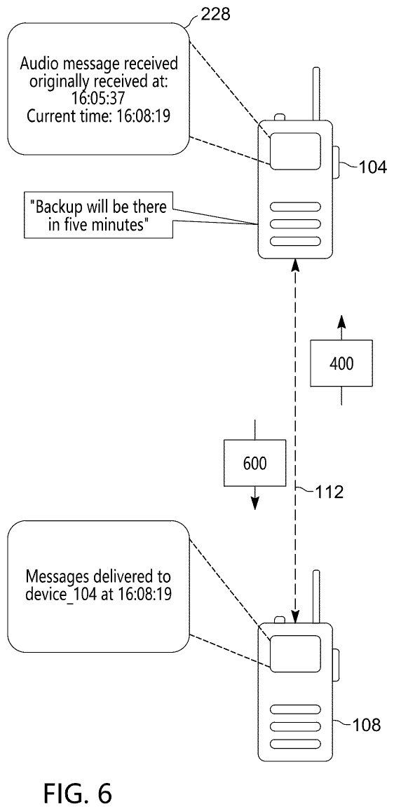

For example, referring to FIG. 6, a schematic diagram of the system 100 at alleviation of the water exposure condition of the device 104 is depicted.

In examples where the device 104 acts as the storage device, the device 104 may retrieve and output the stored message 400 at the speaker 224. The device 104 may additionally present the metadata, such as the receipt time of the message 400 together with the current time at the display 228, to provide the operator with context for the message 400. The device 104 may then send an alert 600 to the source device 108 to indicate alleviation of the water exposure condition and that the message 400 was released or delivered. The source device 108 may display a notification for the operator of the source device 108.

In examples where the source device 108 acts as the storage device, in response to detecting the alleviation of the water exposure condition of the device 104, the device 104 may send the alert 600 to the source device 108 indicating alleviation of the water exposure condition. In response to the alert 600, the source device 108 may display a notification that the water exposure condition of the device 104 has been alleviated and that the message 400 was released, or that it will shortly be released. Further, the alert 600 may act as a release request message, and the device 108 may release the message 400, together with any stored metadata for the message 400. Upon receipt of the stored message 400, the device 104 may output the stored message 400 at the speaker 224 and present the metadata at the display 228. In still further examples, the recipient device 104 may first send a release request message, and then may subsequently send an alert once the message 400 is delivered.

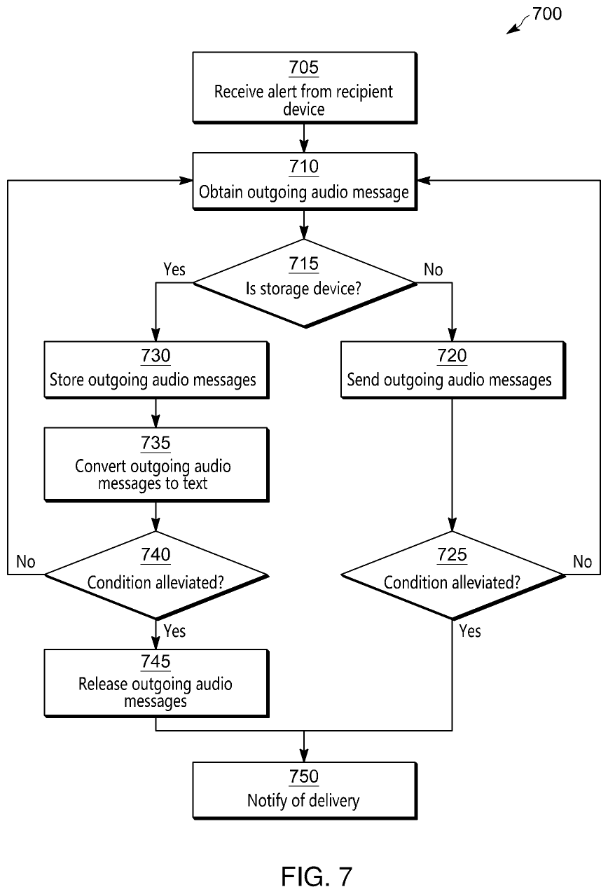

Referring to FIG. 7, a flowchart of an example method 700 of supporting communications management during a water exposure condition of a remote device is depicted. The method 700 will be described below in conjunction with its performance in the system 100, and particularly by the source device 108. In other examples, some or all of the method 700 may be performed by other suitable devices or systems, such as the server 120.

At block 705, the source device 108 receives an alert from the recipient device 104 indicating that the recipient device 104 is experiencing a water exposure condition. In some examples, the alert may simply be informational, such as the alert 404. In response to receiving the alert, the source device 108 may present an indication of the water exposure condition at the recipient device 104, such as a visual or audio notification, and may further present an indication that outgoing audio messages are being stored for later playback.

In some examples, the alert received at block 705 may additionally include and/or function as a storage request message, such as the message 500. That is, the alert and/or message received at block 705 may be, for example, a simple, repeating pulse indicating that RF communications at the recipient device 104 are compromised and therefore indicating to the source device 108 that the source device 108 should act as the storage device.

At block 710, the source device 108 obtains an outgoing audio message from the source device 108 destined for the recipient device 104. For example, the outgoing audio message may be obtained from a user depressing a button of the source device 108 to trigger audio capture by a microphone (i.e., a push-to-talk functionality at the source device 108). In other examples, such as when the method 700 is performed by the server 120, the outgoing audio message may be received from the source device 108 in transit to the recipient device 104.

At block 715, the source device 108 determines whether it is the designated storage device. For example, the source device 108 may make the determination at block 715 based on the alert and/or message received at block 705.

If the determination at block 715 is negative, that is, the source device 108 is not the selected storage device, then the source device 108 proceeds to block 720. At block 720, the source device 108 sends the outgoing audio message according to its regular protocol. That is, since the source device 108 is not the storage device, the outgoing audio message is transmitted to be stored at the selected storage device.

At block 725, the source device 108 determines whether the water exposure condition at the recipient device 104 has been alleviated. In particular, the source device 108 may be notified of the alleviation of the water exposure condition by the recipient device 104, via an alert such as the alert 600. If no such alert has been received, then the source device 108 may determine at block 725 that the water exposure condition of the recipient device 104 has not yet been alleviated.

If the determination at block 725 is negative, then the device 108 returns to block 710 at the subsequent outgoing audio message to continue processing outgoing audio messages.

If the determination at block 725 is affirmative, then the device 108 proceeds to block 750 to provide a notification of delivery of the outgoing audio messages at the recipient device 104, for example via an audio or visual notification to the user.

If the determination at block 715 is affirmative, that is, the source device 108 is the selected storage device, then the source device 108 proceeds to block 730. At block 730, the source device 108 is configured to store the outgoing audio message obtained at block 710. For example, the source device 108 may have a repository in memory in which the audio messages are stored. In particular, the source device 108 may store a message identifier, audio data representing the audio message, and other metadata, such as the time of obtaining the outgoing audio message, and the like. In some examples, the storage of the outgoing audio messages may be performed in conjunction with the sending of the outgoing audio message obtained at block 710. For example, if the devices 104 and 108 are part of a talk group including additional endpoint devices, then the source device 108 may still transmit the outgoing audio messages to be received by the other endpoint devices, while storing the outgoing message for subsequent transmission and playback to the device 104 which is experiencing the water exposure condition.

In some examples, at block 735, in addition to storing the outgoing audio message, the source device 108 may additionally convert the outgoing audio message to a text message (e.g., via a speech-to-text functionality and/or other suitable audio analysis), and the source device 108 may additionally store the text data representing the text message in association with the outgoing audio message. In some examples, at block 735, the source device 108 may transmit the text message to the recipient device 104 instead of the audio message. For example, the source device 108 may make the determination of whether to send the text message based on an indicator of RF communication functionality of the recipient device 104. In other examples, the source device 108 may attempt to transmit the text message to the recipient device 104 irrespective of RF communication capabilities of the recipient device 104, or the source device 108 may simply store the text message.

At block 740, the source device 108 determines whether the water exposure condition of the recipient device 104 has been alleviated, for example based on an alert, such as the alert 600, from the recipient device 104. If no such alert has been received, then the source device 108 may determine at block 740 that the water exposure condition of the recipient device 104 has not yet been alleviated.

If the determination at block 740 is negative, then the device 108 returns to block 710 when the subsequent outgoing audio message is obtained to continue processing outgoing audio messages according to the parameters of the communication management during the water exposure condition.

If the determination at block 740 is affirmative, then the device 108 proceeds to block 745. At block 745, having determined that the water exposure condition at the recipient device 104 is alleviated, the source device 108 may release the stored outgoing audio messages to be transmitted to the recipient device 104. The source device 108 may additionally transmit the metadata and the text data associated with the outgoing audio message, for example to provide context to the recipient device 104 of the outgoing audio message.

At block 750, the device 108 is configured to present a notification of delivery of the outgoing audio messages. For example, the notification may be an audio or visual or other suitable notification, and may include metadata pertaining to the delivery of the outgoing audio message. For example, the notification may include a delivery time of the outgoing message, to alert the user of the device 108 that the audio message was played at the recipient device 104.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method comprising:
detecting, at a water sensor of a recipient device, a water exposure condition of the recipient device;
in response to detecting the water exposure condition, selecting a storage device for storing an incoming audio message from a source device to the recipient device based on the water exposure condition;
storing the incoming audio message at the storage device;
detecting alleviation of the water exposure condition at the recipient device; and
in response to detecting the alleviation of the water exposure condition, releasing the stored incoming audio message for output at the recipient device.

2. The method of claim 1, wherein:
detecting the water exposure condition further comprises detecting a reduction in a radio frequency signal quality below a threshold quality level; and
wherein the selected storage device is remote from the recipient device.

3. The method of claim 2, wherein the storage device is one of a network device and the source device.

4. The method of claim 2, further comprising sending, by the recipient device, a storage request message to the selected storage device to cause the selected storage device to store the incoming audio message.

5. The method of claim 1, wherein
detecting the water exposure condition further comprising detecting that a radio frequency signal quality is above a threshold quality level; and
wherein the selected storage device is one of: the recipient device, the source device, and a network device.

6. The method of claim 1, further comprising:
storing metadata associated with the incoming audio message at the storage device; and
presenting the metadata with the incoming audio message upon releasing the incoming audio message.

7. The method of claim 1, further comprising:
converting the incoming audio message into a text message; and
displaying the text message at the recipient device.

8. The method of claim 1, further comprising:
in response to detecting the water exposure condition, alerting the source device that the incoming audio message is stored at the storage device; and
in response to detecting the alleviation of the water exposure condition, alerting the source device that the incoming audio message is released.

9. The method of claim 1, further comprising:
validating the water exposure condition by a secondary analysis, the secondary analysis including one or more of: video analysis, audio analysis, assigned task analysis, and antenna received signal strength indicator analysis.

10. A communications device comprising:
a water sensor configured to detect a water exposure condition of the communications device;
a communications interface configured to communicate with a source device; and
a controller interconnected with the water sensor and the communications interface, the controller configured to:
in response to detection of the water exposure condition by the water sensor, select a storage device for storing an incoming audio message from a source device to the communications device based on the water exposure condition;
cause the incoming audio message to be stored at the storage device; and
in response to detection of alleviation of the water exposure condition by the water sensor, cause the stored incoming audio message to be released for output at the communications device.

11. The communications device of claim 10, wherein the controller is further configured to:
identify a reduction in a radio frequency signal quality below a threshold quality level; and
select the storage device to be remote from the communications device.

12. The communications device of claim 11, wherein the storage device is one of a network device and the source device.

13. The communications device of claim 11, wherein the controller is further configured to:
send a storage request message to the selected storage device to cause the selected storage device to store the incoming audio message.

14. The communications device of claim 10, wherein the controller is further configured to
detect that a radio frequency signal quality is above a threshold quality level; and
select, as the storage device, one of: the communications device, the source device, and a network device.

15. The communications device of claim 10, wherein the controller is further configured to:
obtain metadata associated with the incoming audio message stored at the storage device; and
present the metadata with the incoming audio message upon releasing the incoming audio message.

16. The communications device of claim 10, wherein the controller is further configured to:
obtain a text message representing the incoming audio message; and
display the text message at the communications device.

17. The communications device of claim 10, wherein the controller is further configured to:
in response to detecting the water exposure condition, alert the source device that the incoming audio message is stored at the storage device; and
in response to detecting the alleviation of the water exposure condition, alert the source device that the incoming audio message is released.

18. The communications device of claim 10, wherein the controller is further configured to:
obtain a validation of the water exposure condition by a secondary analysis, the secondary analysis including one or more of: video analysis, audio analysis, assigned task analysis, and antenna received signal strength indicator analysis.

19. A communications device comprising:
a communications interface configured to communicate with a recipient device; and
a controller interconnected with the communications interface, the controller configured to:
receive an alert from the recipient device, the alert indicating a water exposure condition of the recipient device;
present a notification that outgoing audio messages to the recipient device are stored at a storage device;
receive a subsequent alert from the recipient device, the subsequent alert indicating alleviation of the water exposure condition; and
present a notification that the outgoing audio messages are released from the storage device.

20. The communications device of claim 19, wherein the controller is further configured to:
in response to a storage request message sent in addition to or integrated with the alert, store the outgoing audio messages at the communications device; and
in response to a release request message sent in addition to or integrated with the subsequent alert, release the outgoing audio messages to be transmitted to the recipient device.
